(19) United States
(12) Patent Application Publication
(10) Pub. No.: US 2024/0117137 A1
(43) Pub. Date: Apr. 11, 2024

(54) POULTRY WASTE BIOCHAR FORMULATION AND METHOD FOR PLASTICS

(71) Applicant: Green Unit for Plastic Ltd., Thuwal (SA)

(72) Inventors: Martin Augusto Ibarra, Thuwal (SA); Rodrigo Jimenez Sandoval, Thuwal (SA)

(73) Assignee: Green Unit for Plastic Ltd., Thuwal (SA)

(21) Appl. No.: 18/378,289

(22) Filed: Oct. 10, 2023

Related U.S. Application Data
(60) Provisional application No. 63/414,646, filed on Oct. 10, 2022.

(51) Int. Cl. C08J 9/16; C08G 63/06; C08J 9/00; C08K 3/22

(52) U.S. Cl. CPC C08J 9/16; C08G 63/065; C08J 9/0066; C08K 3/22; C08K 2201/005

(57) ABSTRACT

A biodegradable plastic formulation comprises about 75 wt % to about 85 wt % of a biodegradable polymer, and about 15 wt % to about 25 wt % of poultry waste biochar comprising a particle size of 50 μm or less. A process for producing a biodegradable plastic product comprises forming biochar from poultry waste; formulating about 75 wt % to about 85 wt % of a biodegradable polymer with about 15 wt % to about 25 wt % of the biochar and extruding the formulation to produce pellets; and using the pellets in a production process to produce the biodegradable plastic product.

### CROSS-REFERENCE TO RELATED APPLICATION(S)

This application claims the benefit of U.S. Provisional Application No. 63/414,646 filed on Oct. 10, 2022, the entire contents of which is hereby incorporated by reference.

### BACKGROUND

The present disclosure relates in general to upcycling of waste via biochar conversion and use, and more particularly, to formulations and methods for using poultry waste biochar in plastics.

All of the subject matter discussed in the Background section is not necessarily prior art and should not be assumed to be prior art merely as a result of its discussion in the Background section. Along these lines, any recognition of problems in the prior art discussed in the Background section or associated with such subject matter should not be treated as prior art unless expressly stated to be prior art. Instead, the discussion of any subject matter in the Background section should be treated as part of the inventor's approach to the particular problem, which in and of itself may also be inventive.

Biochar is a black, carbonic residue produced via the thermochemical conversion of biomass via pyrolysis. The biomass is typically organic waste, and examples of feedstocks used for the production of biochar are diverse, but generally include agricultural waste, animal manure or cellulosic sources such as wood or paper. Biochar is best known for use as a soil amendment for upcycling of sequestered carbon from waste back into the ground, and may function to improve water quality while reducing nutrient leaching, irrigation and fertilizer requirements, among other potential benefits. For example, U.S. Pat. No. 9,725,371 B2 by Shearer et al. describes creating biochar from a biomass, and then using the biochar as a soil amendment.

Recently there is a growing interest in using biochar as a filler for plastics and plastic products, including use with biodegradable polymers. For example, U.S. Pat. No. 10,433,543 B2 by Bardosh et al. describe the potential use of biochar as an example filler in a biodegradable polyhydroxyalkanoate (PHA) polymer blend for producing a black, multi-layer biodegradable film that can release bioactive compounds into the soil for promoting plant growth. Further, since the biochar is naturally black, they discuss how petroleum-derived black pigments are no longer necessitated.

In Botta et al., “Use of Biochar as Filler for Biocomposite Blown Films: Structure-Processing-Properties Relationships,” Polymers 2021, 13, 3953, they describe fabricating biocomposite blown films using poly(butylene adipate-co-terephthalate) (PBAT) as the polymeric matrix and beech wood biochar (BC) as the filler, with the biochar filler particles mixed in at 5 wt %, 10 wt %, or 20 wt % of the PBAT-BC composition. The preliminary investigations conducted on melt-mixed PBAT/BC composites showed that PBAT/BC 5 wt % and PBAT/BC 10 wt % were the most appropriate formulations to be processed via film blowing, and that the blown films exhibited mechanical performances adequate for possible application as film for packaging, agricultural, and compost bags.

Similarly, in Hernandez-Charpak et al., “Biochar as a processing additive in poly(butylene adipate-co-terephthalate) (PBAT),” Pharma Excipients, July 2022, they describe using recycled wood biochar as a filler for PBAT to create agricultural mulching films via a blown-film process. They found that changing the particle size of the BC via further milling of the 1 mm to 16 mm particles did not result in significant changes in tensile strength or rheology of the films. Notably, studies such as described above all utilize wood-based biochar as the source material, which is understandable since this is the only commercially available and easy-to-obtain feedstock as of the time of this patent application. However, there is a need to understand and utilize other feedstocks, particularly manure-based feedstocks. Manure disposal, such as from poultry, swine, dairy, and other livestock, is a growing concern for many countries, as such manure can cause negative impacts on the environment even when utilized as a fertilizer for crops. Such impacts include contamination of watersheds and toxic algae blooms, not to mention the undesirable smell of this waste and its effect on local communities.

However, in Hernandez-Charpak et al., “Biochar-filled plastics: Effect of feedstock on thermal and mechanical properties,” Biomass Cony. Bioref. (2022), the authors describe how the physiochemical properties of biochar are sensitive to both feedstock and processing parameters, and that the effect of feedstock on the thermomechanical properties of biochar-filled plastics is not well understood. They show how biochar derived from dairy manure vs. wood chip affected the strength and ductility of filled plastics as well as their thermal behavior, and that this effect was different depending on the polymer matrix utilized, e.g., polypropylene (PP), polycaprolactone (PCL), and polylactic acid (PLA). They conclude that the interactions between biochar feedstock and the polymeric matrix need to be taken into account when using biochar as a filler for plastics.

Accordingly, there is still a need for further characterization and understanding of biochar feedstocks and their effect when used as a filler for various polymers, particularly for manure-based feedstocks which are not as readily available. For example, poultry waste, which can comprise manure and/or poultry litter (e.g., excreta, spilled feed, feathers, bedding materials, etc.), is generated in massive quantities by poultry industries, and improper management can lead to numerous environmental problems. Currently, more waste is being produced by these operations than the industry can effectively manage. Production of biochar from poultry waste is a potentially effective management strategy, and upcycling of this waste into usable plastic formulations and products would be desirable, including but not limited to agricultural mulch films such as described above.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

The present disclosure relates to formulations and methods for using poultry waste biochar in plastics.

In one aspect, embodiments disclosed herein relate to a biodegradable plastic formulation, comprising about 75 wt % to about 85 wt % of a biodegradable polymer; and about 15 wt % to about 25 wt % of poultry waste biochar comprising a particle size of about 50 nm or less.

In another aspect, embodiments disclosed herein relate to an extruded pellet formed from the biodegradable plastic formulation.

In another aspect, embodiments disclosed herein relate to a biodegradable blown film produced from the extruded pellet.

In other aspect, embodiments disclosed herein related to an injection molded product produced from the extruded pellet.

In another aspect, embodiments herein relate to a process for producing a biodegradable plastic product comprising forming biochar from poultry waste; formulating about 75 wt % to about 85 wt % of a biodegradable polymer with about 15 wt % to about 25 wt % of the biochar and extruding the formulation to produce pellets; and using the pellets in a production process to produce the biodegradable plastic product.

Other aspects and advantages will be apparent from the following description and the appended claims.

### BRIEF DESCRIPTION OF THE DRAWINGS

FIG. 1 is a thermogravimetric analysis (TGA) of poultry waste biochar according to an aspect of the present disclosure.

FIG. 2 is a differential scanning calorimetry (DSC) analysis of poultry waste biochar according to an aspect of the present disclosure.

### DETAILED DESCRIPTION

Poultry waste, as defined herein, may comprise the manure or excreta of poultry, or may also comprise poultry litter, which can include excreta, spilled feed, feathers, bedding materials, etc. Poultry may be defined as domesticated birds kept by humans for their eggs, meat or feathers, and includes but is not limited to chickens, quails, and turkeys.

Biochar produced from poultry waste, particularly poultry manure, has remarkably different physiochemical properties from cellulosic or wood-based biochar, and may also be distinguished from biochars produced from other animal manure. For example, in Enders et al., “Characterization of biochars to evaluate recalcitrance and agronomic performance,” Bioresour Technol. 2012 June; 114:644-53, it was found that biochars deriving from diverse feedstocks showed remarkably different compositional and physical properties. As an example, poultry manure (with sawdust) biochar had the second highest ash content behind paper mill sludge biochar, and was significantly higher in ash content than bull manure (with sawdust), corn stover, dairy manure (with rice hulls), hazelnut shells, oak wood, pine wood, and food waste derived biochars. Notably, poultry manure biochar had over 10 times the ash content of the wood based biochars. Other notable differences between poultry manure biochar and others include but are not limited to: about 7 times less fixed carbon content than wood and other animal biochars; over 3 times the volatile content of wood-based biochars; higher nitrogen content than other biochars; pH above 7.5 versus less than 7.5 for wood-based biochars; and high levels of K, Ca, Mg and Na versus wood based biochars.

Despite the significant differences between poultry manure biochar and other feedstock-based biochars such as wood, it was surprisingly discovered by the inventors that poultry waste biochar, such as from poultry manure, could be produced and formulated successfully with a biodegradable plastic polymer, extruded into pellets, and was compatible with film blowing or extrusion, injection molding and other typical manufacturing methods for making plastic products.

Suitable biodegradable plastic polymers for use with the poultry waste biochars of the present disclosure include but are not limited to poly(butylene adipate-co-terephthalate) (PBAT) and polylactic acid (PLA).

The poultry waste biochar may be formulated with the biodegradable polymer in an amount between about 15 to about 25 wt %, while the biodegradable polymer may be present in an amount between about 75 to about 85 wt %. In one example, the poultry waste biochar may be preferably formulated in an amount of about 15 wt % with about 85 wt % biodegradable polymer. In an alternative example, the poultry waste biochar may be formulated in an amount of about 25 wt % with about 75 wt % biodegradable polymer, such as after a heat pre-treatment of the biochar has been performed as described further herein. Alternatively, for some production processes and applications, the heat pre-treatment step may not be necessary, such as where volatile content of the biochar is not a concern.

Further, it was surprisingly discovered that when poultry waste biochar was pulverized into a particle size of 50 μm or less and used as a filler for the biodegradable plastic polymers, no additives or compatibilizers were needed to produce a pellet having suitable properties (e.g., melt flow index) and compatibility with film extrusion (e.g., tear resistance, tensile resistance, % elongation). Further, it was surprisingly discovered that the high ash content of the biochar was beneficial to the mechanical properties of blown films produced using the pellets. For example, the poultry waste biochar of the present disclosure may comprise an ash content of between about 40% w/w to about 60% w/w.

Production of Poultry Waste Biochar

Poultry manure was prepared and processed in preparation of thermochemical conversion to biochar according to the following procedure. Poultry manure was collected from broiler chicken farms and dried until reaching about a 30% moisture content. Grinding was not necessary at this step.

The dried poultry manure, prior to conversion to biochar, was compositionally analyzed and the results are provided in TABLE 1 below.

TABLE 1
POULTRY MANURE COMPOSITION

| Analyte | Result | Unit |
|---|---|---|
| Ash | 13.95 | % |
| Ammonium | 0.58 | % |
| Bulk Density | 0.7281 | g/mL |
| Calcium | 1.29 | % |
| Chromium | 3.49 | Ppm |
| C/N ratio | 8:1 | — |
| Electrical conductivity (1:5) | 17.93 | mS/cm |
| Magnesium | 0.58 | % |
| Mercury | 0.01 | ppm |
| Moisture | 26.88 | % |
| Nickel | 7.62 | ppm |
| Nitrate | 131.08 | ppm |
| Total Nitrogen | 4.39 | % |
| Organic Matter | 86.11 | % |
| Phosphorous (P2O5) | 1.97 | % |
| Phosphorous (P) | 0.86 | % |
| Potassium (K) | 3.49 | % |
| Sodium | 0.44 | % |
| Total Organic Carbon | 36.54 | % |

Biochar was produced by gasification of the dried poultry manure using a down-draft fixed-bed gasifier. The reactor used was a MAVITEC Gasification system. Gasification was conducted by following the specifications of the manufacturer.

However, other suitable processes may be used as is known in the art, for example, as described in US Pub. No. 2009/0031616 A1 by Agblevor, hereby incorporated by reference in its entirety into this application. Examples of fluidized bed reactors can be found in Howard, J. R. (1989), “Fluidized Bed Technology: Principles and Applications.” New York, N.Y.; Adam Higler; Tavoulareas, S. (1991.) Fluidized-Bed Combustion Technology. **Annual Reviews Inc.** 16, 25-27; and Trambouze, P., & Euzen, J. (2004). “Chemical Reactors: From Design to Operation.” (R. Bononno, Trans.). Paris: Editions Technip, which are all hereby incorporated by reference in their entirety.

The poultry manure biochar was compositionally analyzed and the results are provided in TABLE 2 below. The ash content may be inferred from the analytes other than organic carbon. Since the organic carbon was measured at 41.65%, the ash content of the biochar was high as anticipated, falling within the about 40 to about 60% w/w range previously described.

TABLE 2
POULTRY MANURE BIOCHAR COMPOSITION

| Analyte | Result | Unit |
|---|---|---|
| Calcium (Ca) | 2.59 | % |
| Cupper (Cu) | 146.10 | ppm |
| Iron (Fe) | 1459.0 | ppm |
| Magnesium | 1.47 | % |
| Manganese (Mn) | 983.40 | ppm |
| Nitrogen | 2.26 | % |
| Organic Carbon | 41.65 | % |
| pH | 10.22 | — |
| Phosphorous (P) | 1.03 | % |
| Potassium (K) | 5.86 | % |
| Sodium | 0.87 | % |
| Zinc (Zn) | 657.00 | ppm |

The metal oxides present in the ash portion of the poultry manure biochar were also compositionally analyzed, with the results shown in TABLE 3 below.

TABLE 3
POULTRY MANURE BIOCHAR ASH -
METAL OXIDE COMPOSITION

| Metal oxides | wt. % |
|---|---|
| Calcium oxide (CaO) | 26.36 |
| Potassium oxide (K₂O) | 23.45 |
| Phosphorous pentoxide (P₂O₅) | 16.38 |
| Sulfur trioxide (SO₃) | 8.86 |
| Magnesium oxide (MgO) | 7.66 |
| Silica (SiO₂) | 7.65 |
| Sodium oxide (Na₂O) | 4.51 |
| Aluminum oxide (Al₂O₃) | 1.55 |
| Ferric oxide (Fe₂O₃) | 1.12 |
| Manganese oxide (Mn₃O₄) | 0.54 |
| Titanium oxide (TiO₂) | 0.30 |

Biodegradable Plastic Formulations & Properties

The biochar produced as described above was pulverized into a small particle size including 50 μm or less using a DMUP-30B Pulverizer Machine, and then filtered with a 50 micron sieve to yield biochar of uniform 50 μm or less sizing. The biochar was then mixed with biodegradable polymer, in this case PBAT, to produce the biodegradable plastic formulations comprising 15, 20 and 25 wt % biochar (85, 80, and 75 wt % PBAT respectively). Further, a comparative sample of PBAT alone (without biochar) was prepared.

Mixing was performed directly in a feeder Schenck Process at a velocity of 140-190%. The mixture was processed in a Werner & Pfleiderer ZSK 30 twin screw extruder at a temperature profile of 156° C., 155° C., 165° C., 185° C., and 190° C., at a screw velocity of 75 rpm and 24-40% torque and cut in an Accrapak pelletizer to produce pellets of the biodegradable formulation.

Melt flow index of the pellets was measured in a Dynisco D1002 melt flow indexer according to manufacturer specifications.

The formulations and their measured melt flow indexes (MFI) are shown in TABLE 4 below, against the comparative sample of PBAT alone.

TABLE 4

| Sample | MFI (g/10 min @ 190° C. at 2.16 Kg) |
|---|---|
| PBAT alone | 4.98 |
| PBAT/Biochar 15 wt % | 8.89 |
| PBAT/Biochar 20 wt % | 8.40 |
| PBAT/Biochar 25 wt % | 7.80 |

As can be seen from the results of TABLE 4, the MFI or fluidity of PBAT increased when the biochar filler was added, though a slight decrease in overall fluidity was observed with each increasing wt % of biochar in the formulation. Nonetheless, even 25 wt % biochar showed a significant increase in fluidity compared to PBAT alone.

### Blown Film Samples & Testing—Example 1

Each sample of TABLE 4 was then used to produce plastic films using a blown-film process in a Davis-Standard HPE-150A single screw extruder with a temperature profile of 160° C., 170° C., 180° C., 180° C., and 190° C., at a screw velocity of 15 rpm, a roll speed of 2.5 mts./min. and a die temperature of 180° C. The films had a thickness of about 0.10 mm to about 0.13 mm.

Tear resistance of each film formulation was measured with an MTS Universal Testing Machine according to manufacturer specifications. The results of the tear resistance testing are shown in TABLE 5 below for each sample, measured at 23+/−2° C. and 51 mm/min in both the machine direction (MD) and transverse direction (TD).

TABLE 5

| | Tear Resistance (N) | Tear Resistance (N) |
|---|---|---|
| Sample | MD | TD |
| PBAT alone | 3.97 | 4.69 |
| PBAT/Biochar 15 wt % | 4.94 | 5.03 |
| PBAT/Biochar 20 wt % | 0.94 | 2.45 |
| PBAT/Biochar 25 wt % | 0.86 | 3.19 |

As can be seen from the results of TABLE 5, the PBAT/Biochar 15 wt % film had better tear resistance than PBAT alone, whereas increasing the biochar to 20 wt % and 25 wt % resulted in worse tear resistance, largely due to the incorporation of bubbles in the film. However, although biochar at 15 wt % was optimal, some applications may still benefit from the 20 and 25 wt % formulations if tear resistance is not a critical requirement for the application.

Tensile resistance of each film formulation was measured with an MTS Universal Testing Machine according to manufacturer specifications. The results of the tensile resistance testing are shown in TABLE 6 below for each sample, measured at 23+/−2° C. and 500 mm/min in both the machine direction (MD) and transverse direction (TD).

TABLE 6

| | Tensile Resistance (N) | Tensile Resistance (N) |
|---|---|---|
| Sample | MD | TD |
| PBAT alone | 27.86 | 17.40 |
| PBAT/Biochar 15 wt % | 6.18 | 4.67 |
| PBAT/Biochar 20 wt % | 5.82 | 3.18 |
| PBAT/Biochar 25 wt % | 4.05 | 2.45 |

As can be seen from the results of TABLE 6, the biochar filler decreased the tensile resistance of the films relative to PBAT. However, the 15 wt % biochar sample was still adequate for producing agricultural mulch films, for example, while the others could be adequate for other applications depending on the specific requirements.

Percent elongation of each film formulation was measured with an MTS Universal Testing Machine according to manufacturer specifications. The results of the elongation testing are shown in TABLE 7 below for each sample, measured in both the machine direction (MD) and transverse direction (TD).

TABLE 7

| | Elongation (%) | Elongation (%) |
|---|---|---|
| Sample | MD | TD |
| PBAT alone | 612.77 | 611.90 |
| PBAT/Biochar 15 wt % | 343.84 | 230.94 |
| PBAT/Biochar 20 wt % | 327.98 | 107.44 |
| PBAT/Biochar 25 wt % | 178.87 | 32.48 |

As can be seen from the results of TABLE 7, the biochar filler decreased the elongation % of the films relative to PBAT. However, the 15 wt % and possibly 20 wt % biochar samples were still adequate for producing agricultural mulch films, for example, while the others could be adequate for other applications depending on the specific requirements.

### Blown Film Samples—Example 2

To target a thicker film production, biochar formulation sample pellets were produced as described above except using an extruder temperature profile of 185° C., 185° C., 190° C., 190° C., and 190° C. and a torque of 39-44%.

Formulation sample pellets were produced into films using a blown-film process in a Davis-Standard HPE-150A single screw extruder with a temperature profile of 120° C., 155° C., 160° C., 160° C., and 170° C., at a screw velocity of 20 rpm, a roll speed of 1.0 m/min, and a die temperature of 180° C. Notably, the temperature profile used was lower than that used to produce the films according to the Example 1 previously described, and the roll speed was slowed down as well. Further, two formulations were tested, namely PBAT/Biochar 25 wt % and PBAT/Biochar 35 wt %. The roll speed was decreased to produce thicker films compared to Example 1.

It was discovered that neither formulation resulted in a successful film due to the incorporation of bubbles, which caused the film to tear and not be mechanically viable. It was hypothesized that the higher quantity of biochar, particularly in excess of 15 wt %, was causing volatile gases or vapors to be released from the biochar, thus causing the bubble issue.

Accordingly, biochar samples produced as described above, including pulverization and sieving into a particle size of 50 μm or less, were subjected to a pre-treatment temperature of 125° C. for a period of 12 hours to release additional volatiles and moisture.

A subsequent run of the PBAT/Biochar 25 wt % and PBAT/Biochar 35 wt % pellet formulations formed using the heat pre-treated biochar samples resulted in successful film forming and production for the PBAT/Biochar 25 wt % sample, resulting in films having a thickness of 0.15 mm to 0.20 mm and no bubbles or other issues.

It was thus concluded that formulations in excess of 15 wt % poultry waste biochar, including up to 25 wt % biochar, were still feasible for blown film formation when a pre-treatment heating step was utilized as described above. Preliminary assessments also indicated suitable tear resistance, tensile resistance and elongation for use as agricultural mulch films, for example.

However, for the PBAT/Biochar 35 wt % formulation, the film ended up tearing apart due to the increased rigidity of the film resulting from the high biochar content, and was much thicker, around 0.35 mm.

Injection Molding—Planting Pots

Biochar pellets were produced as described above, including pulverization into a particle size of 50 μm or less, as well as the heat pre-treatment step, to make the following formulation samples of TABLE 8 below, wherein PP is polypropylene. However, the extrusion temperature profile for the pellet production was changed to 175° C., 175° C., 185° C., 190° C., and 190° C. and a torque of 70-76%. Each formulation was used in an injection molding process using a Nissei FNX80 injection molding machine, with a temperature profile of 175° C., 175° C., 170° C., 165° C., and 160° C., and injection speed of 50%, an injection pressure of 1025-1125 kg/cm², a holding pressure of 925 kg/cm², and a cooling time of 20 seconds. Five square-shaped planting pots were produced for each formulation (according to the mold design maximum), wherein the top square opening has four sides of identical length and the square bottom has four sides of different but identical length, according to the following dimensions: height 6 cm, top length 6.8 cm each side, bottom length 6.5 cm each side, 1.25 mm thickness. These pots may be used, for example, with seedlings and direct placement in the soil. The sample containing polypropylene was used as a non-biodegradable benchmark for comparison to the biodegradable sample containing only PBAT and biochar.

TABLE 8

| | Proper | | Strength (no |
|---|---|---|---|
| | Shape (no | | breakage during |
| Sample | deformities) | Flexible | normal use) |
| Biodegradable - | YES | Sufficient | Sufficient |
| PBAT 82.5 wt %, | | | |
| biochar 17.5 wt % | | | |
| Non-biodegradable - | YES | Sufficient | Sufficient |
| PBAT 32.5 wt %, | | | |
| PP 50 wt %, | | | |
| biochar 17.5 wt % | | | |

As can be seen from the results, the fully biodegradable formulation was successfully injection molded to produce a planting pot having the desired shape, flexibility, and strength for placement directly in soil, and was of comparable shape, flexibility and strength to the non-biodegradable formulation containing 50 wt % PP. Since such pots are usually formulated with PLA, it was surprising that a seedling pot formulated with only PBAT and 17.5 wt % of the biochar of the present disclosure was successfully injection molded to produce a pot having the desired properties.

Injection Molding—Spoons

Biochar pellets were produced as described above with respect to the injection molding of the seedling pots, including pulverization into a particle size of 50 μm or less, as well as the heat pre-treatment step, to make pellets having a formulation of 17.5 wt % biochar, 32.5 wt % PBAT, and 50 wt % PLA. The formulation was used in an injection molding process using a Babyplast 6/10P injection molding machine, with a temperature profile of 195° C., 190° C., and 190° C., and injection speed of 55%, an injection pressure of 25-28 kg/cm′, a holding pressure of 16 kg/cm′, and a cooling time of 20 seconds. About twenty-five spoons were produced (according to the mold design maximum), and the spoons had the following dimensions: total length 9.8 cm, thickness 1.5-1.6 cm, and scoop length 2.1 cm.

The spoons produced were of proper shape, dimension, and were flexible and strong enough to not break under ordinary bending and use. Accordingly, a formulation of 17.5 wt % biochar, produced according to the methods described above, was successfully used to injection mold spoons having the requisite properties.

Thermogravimetric Analysis (TGA) of Poultry Waste Biochar

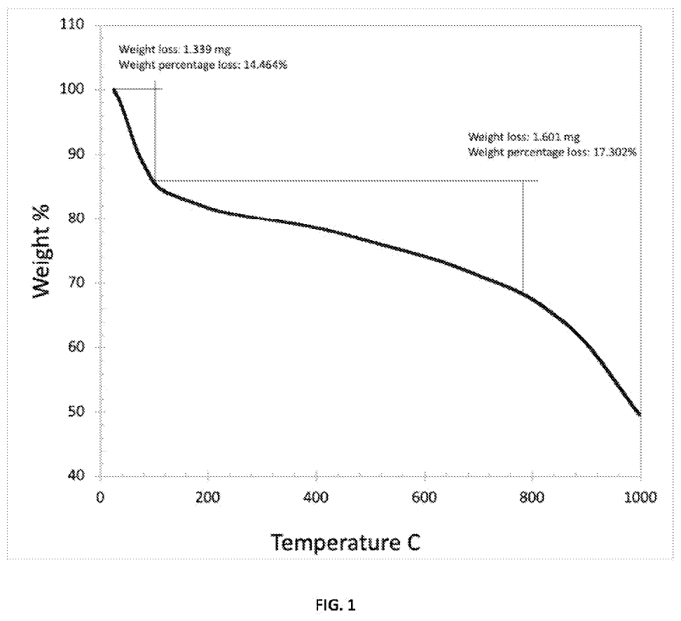

FIG. 1 shows the results of TGA analysis of the poultry waste biochar produced according to the present disclosure. The TGA was performed by ramping up 10° C./min until 1000° C. was achieved, using a thermogravimetric analyzer TGA 5500 from TA Instruments, USA. Two main peaks of weight loss were observed, the first one occurred from room temperature to 100° C., where 14.464% of the weight was lost. Due to the weight loss observed at 100° C., it is possible that the loss was caused by residual water vapor released from the biochar. The second weight loss occurred over a longer temperature range between 100° C. to 800° C., indicating a low content on volatiles and a greater energy input needed to volatilize them. In this second weight loss, 17.302% of mass was lost. Since the extrusion and injection processes described in the present disclosure occur in a temperature range of less than 200° C., the weight loss beyond 200° C. does not affect the production processes described. However, for certain samples, the heat pre-treatment at a temperature above 100° C. was useful to get rid of residual water vapor volatiles in the biochar that may affect the production process by creating bubbles in the resulting production material.

Differential Scanning Calorimetry (DSC) Analysis of Poultry Waste Biochar

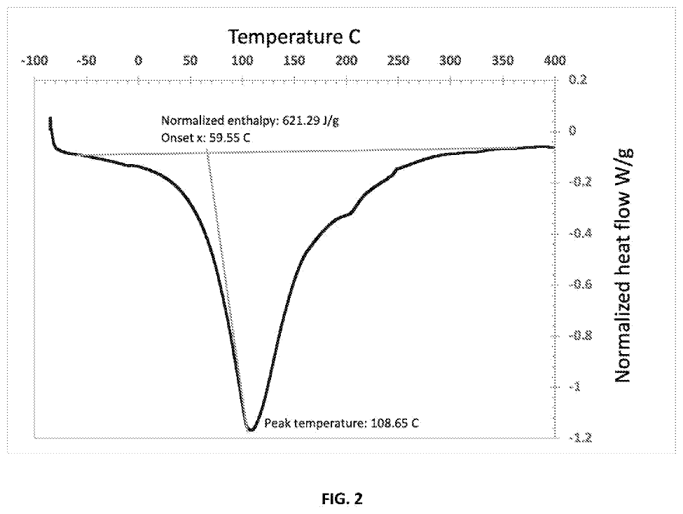

FIG. 2 shows the results of DSC analysis of the poultry waste biochar produced according to the present disclosure. DSC was performed at a temperature range of −85° C. up to 400° C. ramping up 10° C./min, using a differential scanning calorimeter DSC 250 from TA Instruments, USA. The results indicate that there is a phase change of the biochar with an endothermic peak at 108.65° C. that requires a total energy of 621.29 J/g. This phase change may be a transition from a crystalline structure to an amorphous structure or the release of volatiles from the biochar. In such case, this further supports the benefit of a heat pre-treatment as described above prior to using the poultry waste biochar in certain biodegradable plastic formulations and production methods. Although the biochar of the examples above was pre-treated by heating at 125° C. for 12 hours, other heat treatments may be equally effective, such as any heat treatment above 100° C. while adjusting the time of treatment such that sufficient volatile content has been removed, with longer times needed for more removal of volatiles or when performed at lower temperatures closer to 100° C., and shorter times needed for less removal of volatiles or when performed at higher temperatures above 100° C., for example. Ideally a temperature of around 110° C. may be optimal due to the endothermic peak observed via DSC analysis described above. Higher pretreatment temperatures are not recommended due to unnecessary use of energy to release volatiles above 200° C., and because the processes described herein do not use these higher range temperatures. Further, if temperatures are raised too high, this could drive other phase changes, e.g. recrystallization, that could affect compounding and extrusion processes.

While the invention has been described with reference to an exemplary embodiment(s), it will be understood by those skilled in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A biodegradable plastic formulation, comprising:
about 75 wt % to about 85 wt % of a biodegradable polymer; and
about 15 wt % to about 25 wt % of poultry waste biochar comprising a particle size of 50 μm or less.

2. The biodegradable plastic formulation of claim 1, wherein the biodegradable polymer comprises poly(butylene adipate-co-terephthalate).

3. The biodegradable plastic formulation of claim 1, wherein the biodegradable polymer comprises polylactic acid.

4. The biodegradable plastic formulation of claim 1, wherein the poultry waste is poultry litter.

5. The biodegradable plastic formulation of claim 1, wherein the poultry waste is poultry manure.

6. The biodegradable plastic formulation of claim 1, wherein the poultry waste biochar further comprises an ash content of between about 40% w/w to about 60% w/w.

7. An extruded pellet comprising the biodegradable plastic formulation according to claim 1.

8. The extruded pellet of claim 7, comprising a melt flow index of between about 7.80 to about 8.89 g/10 min at 190° C. at 2.16 kg.

9. A biodegradable blown film produced from the extruded pellet of claim 7.

10. The biodegradable blown film of claim 9, comprising a tear resistance of about 0.86 to about 4.94 N in the machine direction and about 3.19 to about 5.03 N in the transverse direction when measured at 23+/−2° C. and 51 mm/min.

11. The biodegradable blown film of claim 9, further comprising a tensile resistance of about 0.86 to about 4.94 N/mm 2 in the machine direction and about 3.19 to about 5.03 N/mm 2 in the transverse direction when measured at 23+/−2° C. and 500 mm/min.

12. The biodegradable blown film of claim 9, further comprising a % elongation of about 178.87 to about 343.84 in the machine direction and about 32.48 to about 230.94 in the transverse direction.

13. The biodegradable blown film of claim 9, comprising an agricultural mulch film.

14. An injection molded product produced from the extruded pellet of claim 7.

15. The injection molded product of claim 14, comprising a biodegradable planting pot or spoon.

16. A process for producing a biodegradable plastic product, comprising:
forming biochar from poultry waste;
formulating about 75 wt % to about 85 wt % of a biodegradable polymer with about 15 wt % to about 25 wt % of the biochar and extruding the formulation to produce pellets; and
using the pellets in a production process to produce the biodegradable plastic product.

17. The process of claim 16, wherein the biodegradable polymer comprises at least one of poly(butylene adipate-co-terephthalate) and polylactic acid.

18. The process of claim 16, further comprising pulverizing the biochar and filtering it to a particle size of 50 μm or less.

19. The process of claim 16, further comprising pre-treating the biochar by heating it above 100° C. to remove residual volatiles prior to producing the pellets.

20. The process of claim 16, wherein the production process comprises film blowing or injection molding.
